(19) United States
(12) Patent Application Publication
(10) Pub. No.: US 2015/0111557 A1
(43) Pub. Date: Apr. 23, 2015

(54) METHOD OF MANAGING CONTACT INFORMATION FOR MOBILE DEVICES ACCORDING TO NETWORK MESSAGES

(71) Applicant: ACER INCORPORATED, New Taipei City (TW)

(72) Inventor: Chia-Yun Chuang, New Taipei City (TW)

(21) Appl. No.: 14/489,488

(22) Filed: Sep. 18, 2014

Related U.S. Application Data
(60) Provisional application No. 61/894,441, filed on Oct. 23, 2013.

(30) Foreign Application Priority Data
Apr. 8, 2014 (TW) 103112890

(51) Int. Cl. H04M 1/247; H04M 1/02

(52) U.S. Cl. CPC H04M 1/2478; H04M 1/0254
USPC 455/418

(57) ABSTRACT

When equipped with a smartcard which stores a plurality of contact numbers, a mobile device may send a communication request to a network by dialing a specific contact number. When unable to establish a connection with the specific number, the network is configured to send an error code to the mobile device. If the mobile device determines that the specific contact number is no longer valid based on the error code, all data related to the specific contact number is deleted in the smartcard and stored in the memory of the mobile device.

### CROSS REFERENCE TO RELATED APPLICATIONS

This application claims the benefit of U.S. provisional application No. 61/894,441 filed on Oct. 23, 2013.

### BACKGROUND OF THE INVENTION

1. Field of the Invention

The present invention is related to a method of managing contact information for mobile devices, and more particularly, to a method of managing contact information for mobile devices according to network messages.

2. Description of the Prior Art

Subscriber identity module (SIM) card is a smartcard that securely stores the international mobile subscriber identity (IMSI) used to identify and authenticate subscribers, short message service (SMS) data and contact information on mobile telephony devices. The hardware structure of a SIM card includes a central process unit (CPU), read-only memory (ROM), random access memory (RAM), electrically erasable programmable read-only memory (EEPROM), and an input/output (I/O) circuit. The hierarchical logic data structure of a SIM card includes 3 types of files: elementary file (EF), dedicated file (DF) and master file (MF).

The elementary files may adopt 3 main types of structures for storing different types of data: transparent, linear fixed and cyclic. A transparent elementary file defines the data that is managed as a stream of bytes, which are addressed by an offset coming from the start of the file. A linear fixed elementary file or a cyclic elementary file is the data grouped into records, which is a block of bytes with a pre-defined size.

FIG. 1 is a diagram illustrating an abbreviated dialing numbers (ADN) elementary file EF_{ADN} defined in the 3GPP specification TS 31.102. As depicted in field 10, the abbreviated dialing numbers elementary file EF_{ADN} adopts linear fixed structure. As depicted in field 20, bytes X+3 to X+12 are used to store supplementary service control (SSC) strings. In other words, the abbreviated dialing numbers elementary file EF_{ADN} can only record a limit amount of contact numbers, among which some old contact numbers may no longer be valid.

In the prior art method of managing contact information for mobile devices, if there is no space available in the abbreviated dialing numbers elementary file EF_{ADN} of the SIM card, the user is required to manually delete old contact numbers so that new contact numbers can be stored. The prior art method is inefficient and causes inconvenience to the user.

### SUMMARY OF THE INVENTION

The present invention provides a method of managing contact information for a mobile device according to network messages. The method includes inserting a smartcard which stores a plurality of contact numbers into the mobile device; the mobile device sending a communication request to a network by dialing a specific contact number among the plurality of contact numbers stored in the smartcard; the network sending an error code to the mobile device when unable to establish a connection with the specific contact number; the mobile device determining whether the specific contact number is invalid according to the error code received from the network; and the mobile device deleting all information associated with the specific contact number stored in the smartcard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an abbreviated dialing numbers elementary file EF_{ADN}.

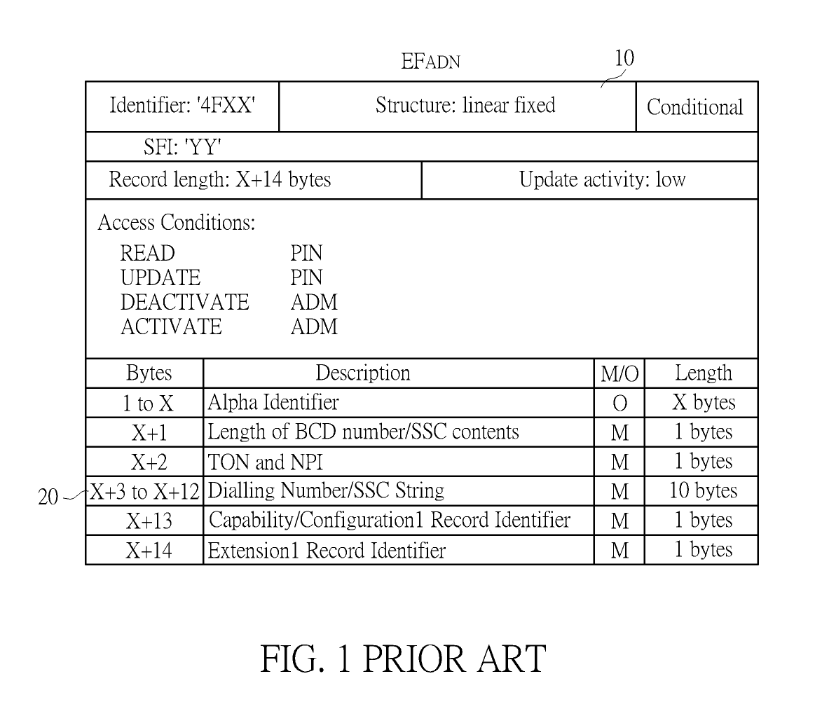

FIG. 2 is a flowchart illustrating a method of managing contact information for mobile devices according to network messages in the present invention.

### DETAILED DESCRIPTION

The present invention provides a method of managing contact information for mobile devices according to network messages. The present method may be applied to electronic devices including, but not limited to, mobile telephones, personal digital assistants, handheld computers, tablet computers, nettop computers, or laptop computers, or other devices with similar telecommunication capabilities. However, the type of mobile device does not limit the scope of the present invention.

The present method may be applied to mobile devices inserted with various types of smartcards including, but not limited to, a SIM card for global system for mobile communications (GSM) system, a USIM card for universal mobile telecommunications system (UMTS), or a removable user identity module (R-UIM) card/code division multiple access (CDMA) user identity module (CSIM) card for CDMA systems. However, the type of the smartcard does not limit the scope of the present invention.

The present method may be applied to a mobile device inserted with a smartcard of various sizes including, but not limited to, a standard Mini SIM card, a Micro SIM card or a Nano SIM card. However, the size of the smartcard does not limit the scope of the present invention.

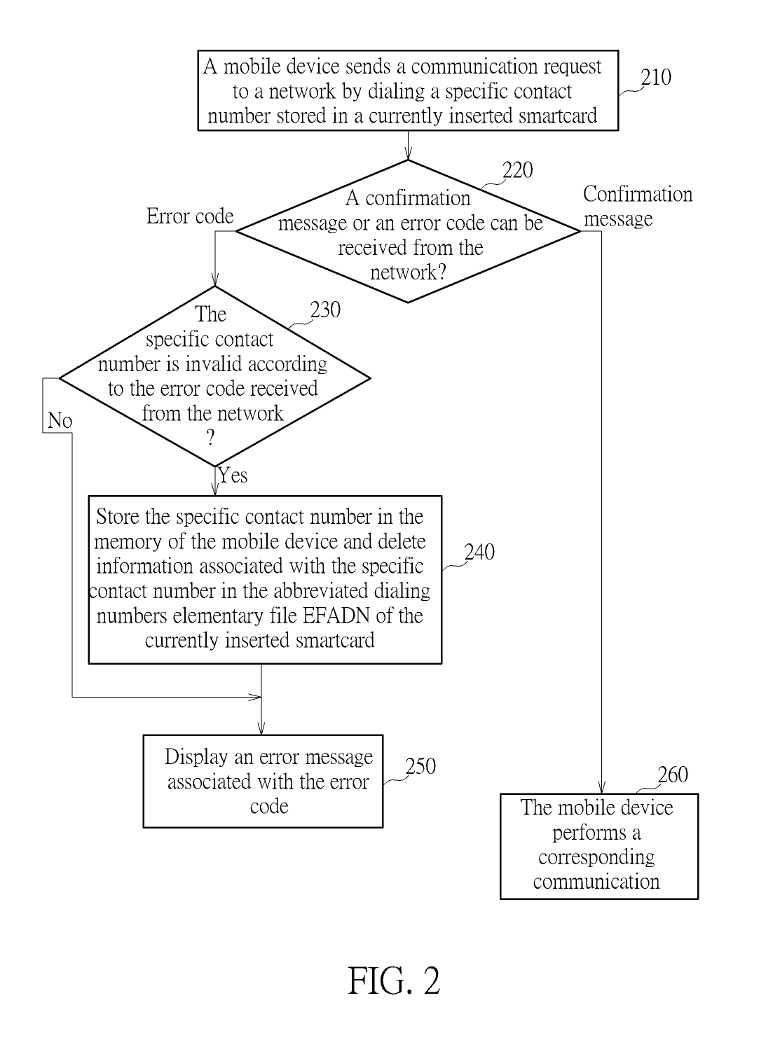

FIG. 2 is a flowchart illustrating a method of managing contact information for mobile devices according to network messages in the present invention. The flowchart in FIG. 2 includes the following steps:

Step 210: a mobile device sends a communication request to a network by dialing a specific contact number stored in a currently inserted smartcard; execute step 220.

Step 220: determine whether a confirmation message or an error code can be received from the network: if the confirmation message can be received from the network, execute step 260; if the error code can be received from the network, execute step 230.

Step 230: determine whether the specific contact number is invalid according to the error code received from the network: if yes, execute step 240; if no, execute step 250.

Step 240: store the specific contact number in the memory of the mobile device and delete information associated with the specific contact number in the abbreviated dialing numbers elementary file EF_{ADN} of the currently inserted smartcard; execute step 250.

Step 250: display an error message associated with the error code.

Step 260: mobile device performs a corresponding communication.

In step 210, the smartcard of the mobile device may contain one or multiple pieces of contact information, such as a phonebook which records one or multiple contact names and contact numbers. A user interface may be provided on the mobile device so that a user can dial a specific contact number of a specific contact name by inputting at least a part of the specific contact name, inputting at least apart of the specific contact number, selecting the specific contact name/number from a list, pressing a pre-set hotkey or narrating a command to phone the specific contact name/number. However, the method of dialing the specific contact name/number does not limit the scope of the present invention.

After receiving the communication request from the mobile device, the network attempts to establish a connection with the specific contact number. If the network is able to establish a connection with the specific contact number, the network may send the confirmation message instep 220 so that the mobile device performs the corresponding communication in step 260. If the network is unable to establish a connection with the specific contact number, the network may determine the failure cause and send the corresponding error code in step 220.

In the present invention, the error code may be an integrated service for digital network user part (ISUP) cause code of an integrated service for digital network (ISDN) or a session initiation protocol (SIP) message of a voice over Internet protocol (VoIP). The failure cause of establishing the connection may be due to invalid contact number, network hardware breakdown, network resource temporally being unavailable or insufficient network privilege. However, the form of the error code sent by the network does not limit the scope of the present invention.

If the network fails to establish a connection with the specific contact number due to invalid contact number, the error code received by the mobile device from the network in step 220 may include an ISUP cause code 1 and “unallocated/unassigned number” described in SIP message “404 Not found”, an ISUP cause code 22 and “number changed” described in SIP message “301 Moved Permanently” or “410 Gone”, or an ISUP cause code 28 and “invalid number format/address incomplete” described in SIP message “484 Address incomplete”. However, the form of the error code does not limit the scope of the present invention.

If the network fails to establish a connection with the specific contact number due to network hardware breakdown, the error code received by the sending mobile device from the network in step 220 may include an ISUP cause code 27 and “destination out of order” described in SIP message “502 Bad Gateway”, an ISUP cause code 38 and “network out of order” described in SIP message “503 Service unavailable”, or an ISUP cause code 41 and “temporary failure” described in SIP message “503 Service unavailable”. However, the form of the error code does not limit the scope of the present invention.

If the network fails to establish a connection with the specific contact number because network resource is temporally unavailable, the error code received by the sending mobile device from the network in step 220 may include an ISUP cause code 17 and “user busy” described in SIP message “486 Busy here”, an ISUP cause code 42 and “switching equipment congestion” described in SIP message “503 Service unavailable”, an ISUP cause code 47 and “resource unavailable” described in SIP message “503 Service unavailable”, or an ISUP cause code 65 and “bearer capability not implemented” described in SIP message “488 Not Acceptable Here”. However, the form of the error code does not limit the scope of the present invention.

If the network fails to establish a connection with the specific contact number due to insufficient network privilege, the error code received by the sending mobile device from the network in step 220 may include an ISUP cause code 55 and “incoming calls barred within CUG” described in SIP message “403 Forbidden”, an ISUP cause code 57 and “bearer capability not authorized” described in SIP message “403 Forbidden”, or an ISUP cause code 87 and “user not member of CUG” described in SIP message “403 Forbidden”. However, the form of the error code does not limit the scope of the present invention.

If the error code received by the mobile device from the network in step 220 is associated with network hardware breakdown, network resource temporally being unavailable or insufficient network privilege, it can be determined in step 230 that the specific contact number is still valid. That is, by repairing network hardware, providing available network resource or acquiring sufficient network privilege, the mobile device may successfully dial the specific contact number at the next attempt. Under such circumstance, the error message associated with the error code may be displayed on the mobile device in step 250 to inform the user of the failure cause, while the data stored in the smartcard remains unchanged.

If the error code received by the mobile device from the network in step 220 is associated with invalid number, it can be determined in step 230 that the specific contact number is no longer valid. Under such circumstance, step 240 is executed for storing the specific contact number in the memory of the mobile device and deleting all information associated with the specific contact number in the abbreviated dialing numbers elementary file EF_{ADN} of the currently inserted smartcard. Next, the error message associated with the error code may be displayed on the mobile device in step 250 to inform the user of the failure cause.

In step 240, all contact numbers which have been determined to be invalid may be stored in s specific directory in the memory of the mobile device. The user may then decide whether these invalid contact numbers should be permanently erased.

The present invention provides a method of efficiently managing contact information for mobile devices according to network messages so that invalid contact numbers stored in the abbreviated dialing numbers elementary file EF_{ADN} of the smartcard can be automatically deleted. The present invention can provide a user-friendly environment since the user is no longer required to manually delete old contact numbers frequently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing contact information for a mobile device according to network messages, comprising:
inserting a smartcard which stores a plurality of contact numbers into the mobile device;
the mobile device sending a communication request to a network by dialing a specific contact number among the plurality of contact numbers stored in the smartcard;
the network sending an error code to the mobile device when unable to establish a connection with the specific contact number;
the mobile device determining whether the specific contact number is invalid according to the error code received from the network; and
the mobile device deleting all information associated with the specific contact number stored in the smartcard.

2. The method of claim 1, further comprising:
the mobile device displaying an error message associated with the error code after receiving the error code from the network.

3. The method of claim 1, wherein:
the mobile device deleting all information associated with the specific contact number includes deleting all information associated with the specific contact number stored in an abbreviated dialing numbers elementary file (EF_{ADN}) of the smartcard.

4. The method of claim 1, further comprising:
the mobile device storing the specific contact number in a memory of the mobile device when determining that the specific contact number is invalid.

5. The method of claim 1, wherein the error code includes an integrated service for digital network user part (ISUP) cause code of an integrated service for digital network (ISDN) or a session initiation protocol (SIP) message of a voice over Internet protocol (VoIP).

6. The method of claim 5, further comprising:
the mobile device determining that the specific contact number is invalid when the error code includes an ISUP cause code 1, an ISUP cause code 22 or an ISUP cause code 28.

7. The method of claim 5, further comprising:
the mobile device determining that the specific contact number is invalid when the error code includes an SIP message “404 Not Found”, an SIP message “301 Moved Permanently” or an SIP message “410 Gone”.

8. The method of claim 1, further comprising:
the network determining a failure cause when unable to establish the connection with the specific contact number and sending the error code associated with the failure cause to the mobile device.

9. The method of claim 1, wherein the failure cause indicates:
the specific contact number is an unallocated number;
the specific contact number is an unassigned number;
the specific contact number has been changed;
the specific contact number has an invalid number format; or
the specific contact number has an incomplete address.
